(19) United States
(12) Patent Application Publication
(10) Pub. No.: US 2007/0029007 A1
(43) Pub. Date: Feb. 8, 2007

(54) Machine and process for sampling, venting or viewing suspected HAZMAT drums, containers, ductwork or various enclosures without leakage

(76) Inventor: Douglas Carl Hutchinson, Penrose, CO (US)

Correspondence Address: Douglas Carl Hutchinson, 1460 Valley Drive, Penrose, CO, 81240, US

(21) Appl. No.: 11/188,986

(22) Filed: Jul. 25, 2005

(51) Int. Cl. F16L 55/07; B65B 3/04; G01M 19/00

(52) U.S. Cl. 141/330; 137/317; 137/320; 73/866.5; 73/863.86

(57) ABSTRACT

This device provides an effective means of remotely sampling, depressurizing, viewing, introducing agents or neutralizing potentially hazardous materials primarily in sealed containers or areas where it is desired to prevent environmental leakage or venting. This invention installs a semi permanent closable port into a drum or container, duct, wall or other enclosed area where access is desired.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Industrial Hygiene, Homeland Security and HAZMAT handling and more specifically to a Device and Process For Sampling, Venting or Viewing Suspected HAZMAT Drums, Containers, Ductwork or Various Enclosures Without Leakage.

This invention is very compact and drives a valve into a container while keeping the container sealed. The valve can be left in place allowing for secondary tests or fluid sampling after initial venting and testing. Until now, no such device has existed. A need exists for a uniform and safe method for sampling drums and containers in compliance with OSHA regulations, 29 CFR) Hazardous waste operations and emergency response. −1926.650)(1)(ix) et seq.

OSHA is clear that any unmarked drum must be treated as one containing hazardous materials.

The instant device is designed to penetrate, vent, sample and re-seal containers from a safe distance. The heart of the system is a configurable probe, that once installed in a container can be opened or closed at any time thus preventing hazardous materials from leakage into the atmosphere. Of particular use is the probes ability to seal and vent a pressurized drum or container, thereby minimizing explosion or exposure risk to personnel.

Numerous devices have been invented that provide for some form of sampling but prior to this invention, nothing has been submitted that combines all of the necessary elements to safely sample a broad spectrum of materials in potentially pressurized containers and reseal the container. This invention combines all of the above and does so remotely, from a safe distance.

The prior art is best demonstrated in devices patented by Volz U.S. Pat. No. 5,841,038 and by Garcia, et al in U.S. Pat. No. 6,065,488. These are two different approaches dealing with the problem of sampling suspected HAZMAT containers.

Efforts have been made to both penetrate and seal, such as U.S. Pat. No. 6,065,488, which uses a chemical sealant that could react with certain materials, further, the sealant must be heated up to 100 degrees centigrade, further increasing risk. U.S. Pat. No. 6,065,488 also drills through a container wall increasing risk of spark and lacks remote capability.

The Volz device, while robust, is cumbersome and complicated in comparison to this invention. It requires large compressed air cylinders and air hose to operate. Since the Volz device uses a fixed needle, it must be decontaminated after each use—a substantial drawback if scores of containers must be tested, especially if time is critical. The Volz device, once removed, leaves a hole, leaking contents into the environment.

### BRIEF SUMMARY OF THE INVENTION

The primary object of the invention is to satisfy the need for a flexible, uniform, modular and safe method for sampling Hazmat drums and other containers from a safe distance, without leakage, with probes to suit almost any need, from viewing to sampling for radioactive or other hazardous material.

Another objective is to provide a method to prevent hazardous contents from leaking out, before during or after testing.

Another object is to provide a means of remotely accessing any enclosed area with a camera or sensors.

Another object is to reduce the size of the probe and to define a better point to minimize wall distortion

Yet another objective is to accomplish all of the above in an easy to operate system that is small enough to fit in one hand.

Other objects and advantages of the present invention will become apparent from the following descriptions, taken in connection with the accompanying drawings, wherein, by way of illustration and example, an embodiment of the present invention is disclosed.

This invention is intended to provide the means by which a probe can be inserted into a sealed container of unknown content or suspected of containing hazardous materials without leaking the container's contents. The probe may be a camera, a venting port, gas sampling port, a liquid sampling port or a sensor. The probe is highly resistant to corrosives and non-reactive to most known materials. This invention prevents leakage of hazardous materials while sampling and afterwards. It allows for re-sampling at any time and vents pressurized containers to provide for safe handling.

In its preferred embodiment, gas pressure, controlled by a solenoid, remotely is released into a cylinder, driving a Piston (FIG. 4) against a Lever (FIG. 4) (FIG. 3 and FIG. 4). The Lever (FIG. 4) drives the probe (FIG. 1 and FIG. 2) against a container wall by first contacting the seal. After a seal has been established, the probe continues into the container wall. The tip cuts three sides of the entry hole, and rolls the container wall away, still attached to the container to prevent contaminating the container contents with wall material or paint. Barbs on the tip of the probe flex inwards while passing through the wall and expand after passing, When the driving force is relaxed, the barbs grip the inside edge of the wall, locking the Probe (FIG. 1 and FIG. 2) in place. A valve (solenoid or manual) in the Probe (FIG. 1 and FIG. 2) allows for testing, venting and re-sealing. Quick connects allow for tubing be attached to the Probe (FIG. 1 and FIG. 2). Surface mount sensors in the Probe (FIG. 1 and FIG. 2) can detect certain conditions of the headspace air.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a general perspective view of the Probe (FIG. 1 and FIG. 2) Assembly portion of the invention.

FIG. 2 is an exploded modular view of the Probe (FIG. 1 and FIG. 2) Assembly. The valve is depicted in this drawing as an electrically controlled device although simple manual configurations are anticipated. The drawing illustrates barbs near the tip to secure the device to a drum. Other methods of expansion devices, such as springs, elastic materials or toggles are anticipated by this application

FIG. 3 is a general perspective view of the Installation Tool (FIG. 3 and FIG. 4)

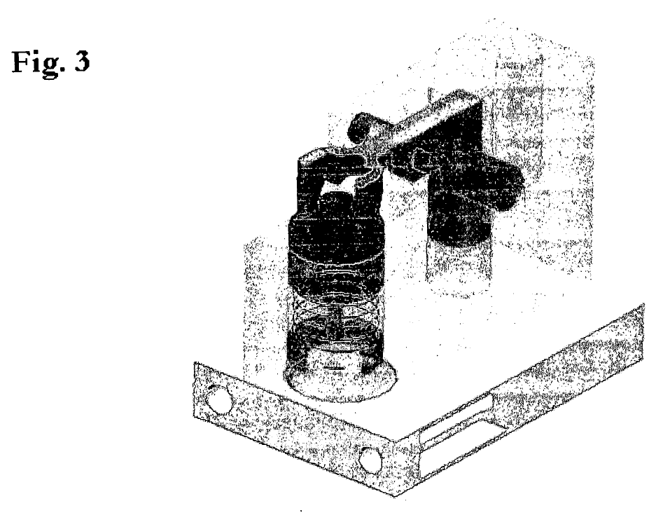

FIG. 4 is an exploded view of the Installation Tool (FIG. 3 and FIG. 4) with the Probe (FIG. 1 and FIG. 2) included in the drawing. This is a simplified drawing suggesting one method of constructing the Installation Tool (FIG. 3 and FIG. 4). A 12 Gram CO2 Cartridge is shown but the device may also operate by way of a separate cylinder of compressed gas, a hydraulic source or a motor driven screw.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### Description of a Preferred Embodiment

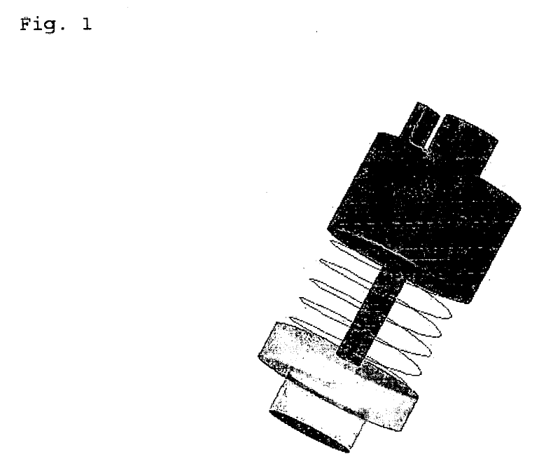

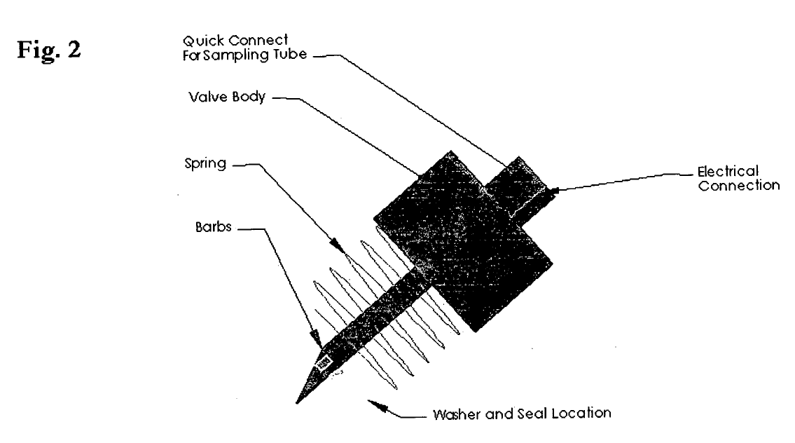

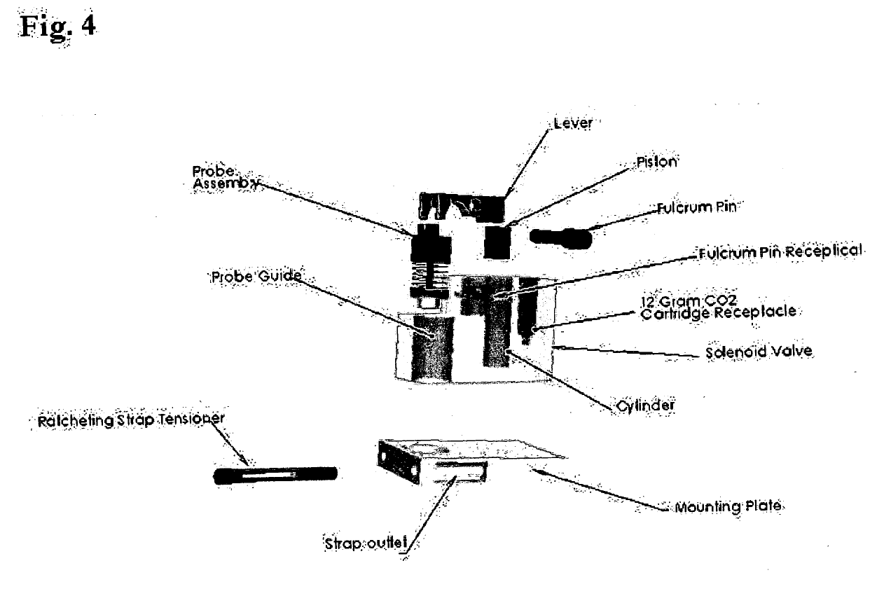

In its preferred embodiment, the tool is connected to a cable leading to a remote control switch and battery. (alternatively a wireless apparatus can be employed) The lockout/tagout key is removed from the remote. The installation tool is attached to a container by means of a ratcheting strap. A small cylinder of compressed gas is installed in the tool and opened. A probe is selected and installed in the tool by removing the installation Lever (FIG. 4). To remove the Lever (FIG. 4) a pin is removed from the fulcrum. The probe is inserted into the probe guide and the Lever (FIG. 4) is reinstalled. A sampling hose is connected to the probe, which may lead to a container capable of containing excess-vented pressure. The technician then connects the remote cable and exits to a safe location as defined by OSHA. When the area is cleared and it's safe to do so, the technician inserts his key into the remote, enabling the device. Feedback from the device indicates that there is sufficient pressure available. The Probe (FIG. 1 and FIG. 2) may now be deployed.

When the deployment switch in engaged, a solenoid will open, allowing a cylinder to pressurize. The pressure will move a Piston (FIG. 4) away from the container, pushing against the installation Lever (FIG. 4). The Lever (FIG. 4), in turn, will push the probe towards the container. An expanded Teflon seal will contact the container first, its pressure against the container increasing as the probe is pushed farther in. The spring behind the seal keeps the seal pressed tight as the probe tip passes through the seal. The probe tip is then pressed through the container wall exposing it to the material inside the container. Barbs on the probe tip will compress as they pass through the container wall and expand after passage. There is a small port in the installation tool cylinder allowing a controlled leak of pressurized gas. As the gas escapes, the pressure that moved the Piston (FIG. 4) will subside, allowing the probe spring to pull the probe back, drawing the barbs into contact with the container wall. The barbs hold the probe securely in position, maintaining spring pressure against the seal. A proximity switch confirms to the technician by signaling the remote unit that the probe has been properly installed.

If the probe is equipped with a pressure transducer advising the operator that the container is under pressure, the technician may open the probes solenoid valve to vent the overpressure. The contents may be sampled at this time or later. The installation tool may be removed as the probe is securely affixed to the container wall.

The probe is a simple device, consisting of a valve head, a tube cut at an angle and sharpened on three sides, with barbs, just below the opening, a seal and washer, a spring and one or more quick connect ports. If the probe is equipped with a solenoid valve or sensors, an electrical plug will be located near the quick connect.

The installation tool has a guide to prevent lateral movement of the Probe (FIG. 1 and FIG. 2). A Lever (FIG. 4) drives the probe through the container wall. A Lever (FIG. 4) has been chosen to keep the mass of the device as close to the container as possible. (A direct acting ram, such as the Volz device, by protruding farther from the container, unnecessarily increases the moment and requires greater force to attach the tool. By keeping the ram only a couple inches away from the container, the tool can also be placed in tighter spaces as well.) The Lever (FIG. 4) rocks on a removable pin and is moved by a Piston (FIG. 4), spring or electric motor. If a Piston (FIG. 4) is used, it is driven by a compressed gas, such as a 12-gram co2 cartridge, controlled by a solenoid or timer. The solenoid is connected by wire with a remote switch with a lockout key or by radio or infrared remote. A pressure switch can be located in the passage between the gas supply and the solenoid to light an L.E.D. on the remote to make the operator aware that the unit is fully pressurized. Likewise, a pressure transducer could be placed in the Probe (FIG. 1 and FIG. 2) and coupled with the remote to advise the operator of unsafe pressure in the container being tested. A second switch in the remote would operate a solenoid valve in the probe to vent excess pressure or for sampling.

While the invention has been described in connection with a preferred embodiment, it is not intended to limit the scope of the invention to the particular form set forth, but on the contrary, it is intended to cover such alternatives, modifications, and

What is claimed is:

1. a. The insertion tool is a self contained device consisting of a source of compressed gas, such as a CO2 cartridge, a pneumatic ram with vent, which may join with a lever or eccentric shaft to drive the probe, a guide for the probe, a solenoid and electrical connections for remote operation;
b. pressure and proximity sensors may be used for feedback as well as wireless or timed actuation;
c. a pump and N.B.C. sensors or camera could be incorporated into the insertion tool or separately;
d. a means of attaching the insertion tool to the container being tested includes straps or braided wire coupled to a ratcheting mechanism for tightening;
e. A pneumatic tensioner could also be employed;
f. alternatively, an electrical motor may be used to drive the probe either with a linear actuator or an eccentric device;
g. alternatively, an explosive charge can be used to drive the probe;
h. alternatively, a spring can be used to drive the probe.
i. The probe tip could also be coated with abrasive material and rotated to penetrate the cylinder

2. A Probe capable of penetrating steel plastic or other materials is made of a high strength material, preferably resistant to making sparks, not chemically reactive and corrosion resistant such as titanium or Beryllium Copper:
a. the probe locks to the inside of the material penetrated by means of barbs or toggles, spring loaded or mechanically spread or by means of an elastic material to contract through the hole and expanding after passage;
b. the probe has a sharp tip to penetrate the container being tested and is hollow to allow the sampling of gas or fluid through it;
c. the optimal shape of the tip is an acute angle, traversing through the cylinder from the tip, across a diagonal tangent, 180 degrees to the other side of the cylinder, sharpened from the leading edge of the point and along both sides but flattened on the trailing side to prevent the coplete cutout and removal of material;
d. the probe is sealed with a stable, inert material such as Gor-Tex expanded Teflon;
e. the seal is held in place with a spring between the head of the valve and a washer behind the seal, held in place by the barbs on the inside of the wall and squeezing the seal against the wall of the container being tested, a second seal may be included on the inside, in the vicinity of the barbs;
f. the washer is the same size as the probe head to aid in guiding the probe into place; the washer may be corrugated to facilitate the application of a bonding agent for increased grip.

3. The probe head acts as the upper guide and anvil for driving the probe through container walls or other surfaces:
a. incorporates a zero leak coupling to attach tubing for venting, sampling, adding agents etc.;
b. the probe head has room for sensors such as pressure transducers, N.B.C. sensors or CCTV cameras; may be manual or a remotely operated value;
d. electrical connectors are employed to effect a remote interface via cable or wireless connection;

4. A remote control connected by cable or wireless enables the technician to operated the insertion tool and probe from a safe distance:
a. feedback, such as container or operating pressure or proximity from the probe and insertion tool may be displayed on the remote panel;
b. a lockout key is incorporated into the remote to prevent its use while the technician is away;
c. a switch on the remote closes the circuit to cause the probe to be inserted;
d. a second switch causes the valve on the probe to open or close, thereby venting or sealing the container.
